(19) United States
(12) Patent Application Publication
(10) Pub. No.: US 2014/0330620 A1
(43) Pub. Date: Nov. 6, 2014

(54) COMPUTER-IMPLEMENTED SYSTEM AND METHOD FOR BENCHMARKING, ACCOUNTING, ANALYSIS, AND COST FORECASTING

(71) Applicants: FRANK ABELLA, Edision, NJ (US); Mark Magyar, Morristown, NJ (US); Michael Fedorochko, Bound Brook, NJ (US)

(72) Inventors: FRANK ABELLA, Edision, NJ (US); Mark Magyar, Morristown, NJ (US); Michael Fedorochko, Bound Brook, NJ (US)

(21) Appl. No.: 14/268,426

(22) Filed: May 2, 2014

Related U.S. Application Data
(60) Provisional application No. 61/818,909, filed on May 2, 2013.

(51) Int. Cl. G06Q 10/06; G06Q 40/00

(52) U.S. Cl. CPC G06Q 10/06375; G06Q 40/12; G06Q 10/0639
USPC 705/7.37

(57) ABSTRACT

A computer-implemented method for benchmarking, accounting, analysis, and cost forecasting is provided. In exemplary embodiments, the method may comprise, at a server having one or more processors and memory storing one or more programs for execution by the one or more processors: harvesting raw data from a plurality of sources; indexing the harvested data according to predetermined data categories relating to municipalities; organizing the data based on the indexed data and the geographic location associated with the data; storing the organized data in a database; and generating and displaying a profile page for a selected region based on the organized data stored in the database.

### CROSS-REFERENCE TO RELATED APPLICATIONS

The present application claims priority to U.S. Provisional Patent Application Ser. No. 61/818,909 entitled “Computer-Implemented System and Method for Benchmarking, Accounting, Analysis, and Cost Forecasting,” filed May 2, 2013, the disclosure of which is incorporated herein by reference in its entirety as if fully set forth herein.

### BACKGROUND

1. Field of the Invention

Embodiments of the present invention are generally related to computer-implemented systems and methods for benchmarking, accounting, analysis, and cost forecasting. More specifically, embodiments of the present invention relate to computer-implemented systems and methods for benchmarking, accounting, analysis, and cost forecasting by providing a platform to help decision makers by coalescing data from discrete locations in various formats into a uniform format.

2. Description of Related Art

There exists a vast universe of public data accessible in separate systems and inaccessible via a single system or method. Public data is critical for decision makers in the public and private sector to make informed financial and operational decisions. Government budgets at every level from Federal to Municipal are under tremendous strain. For example, the New Jersey state budget has recently faced a projected $3 billion structural deficit. In such fiscally chaotic times, it is imperative that both policy makers and private companies have access to impartial data and information. However, without easy access to precise and sophisticated datasets, the task of making informed decisions and planning appropriately becomes nearly impossible.

The current economic strain on both the public and private sector makes data-driven decision-making more important than it has ever been. Structuring public data in a uniform way and providing a user-friendly interface could improve the method by which decision makers access and manipulate this data and make it easier to compare this data across locations. The government budgeting process could be improved significantly by requiring the budget to contain future expenditures and revenues over a predetermined period. Still, many obstacles can prevent smart budgeting and utilization of public data, including: lack of access to long term planning and financial forecasting tools; need for impartial and independent sources of financial, operational and comparative data; lack of comprehensive assembly of all data impacting budgeting and forecasting, including contracts, census and demographics, shared services, policy and regulations, and economic forecasts; lack of a single cohesive location that centralizes public data and makes it easy to find and utilize.

Current systems simply provide retrospective, static information. As such, a need exists for a more robust tool that combines public datasets from a multitude of public and private sources at the local, state, and federal levels. A tool that combines large scale public datasets from sources like the U.S. Census with municipal budget revenue and expenditure information, policy considerations, local contract details and careful financial analysis, would enable municipalities, other government entities, and private companies to make better educated, proactive, big picture decisions.

### SUMMARY

Embodiments of the present disclosure generally relate to a computer-implemented method for benchmarking, accounting, analysis, and cost forecasting. In one embodiment, a computer-implemented method for benchmarking, accounting, analysis, and cost forecasting may comprise at a server having one or more processors and memory storing one or more programs for execution by the one or more processors, harvesting raw data from a plurality of sources; indexing the harvested data according to predetermined data categories relating to municipalities; organizing the data based on the indexed data and the geographic location associated with the data; storing the organized data in a database; and generating and displaying a profile page for a selected region based on the organized data stored in the database.

In another embodiment of the present disclosure, a computer-implemented method for benchmarking, accounting, analysis, and cost forecasting may comprise at a server having one or more processors and memory storing one or more programs for execution by the one or more processors, harvesting raw data from a plurality of sources; indexing the harvested data according to predetermined data categories relating to municipalities; organizing the data based on the indexed data and the geographic location associated with the data; storing the organized data in a database; generating and displaying a profile page for a selected region based on the organized data stored in the database; analyzing the organized data and indicating if the data meets a predetermined threshold; and forecasting the expected future values of the organized data and displaying the forecasted data near real time data in a coherent display on the profile page.

In yet another embodiment of the present disclosure, a system may comprise at least one server that may comprise one or more processors; and memory; wherein the at least one server is adapted to harvest raw data from a plurality of sources; index the harvested data according to predetermined data categories relating to municipalities; organize the data based on the indexed data and the geographic location associated with the data; store the organized data in a database; and generate and display a profile page for a selected region based on the organized data stored in the database.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a system-level network diagram of system of a benchmarking, accounting, analysis, and cost forecasting system in accordance with one embodiment of the present disclosure;

FIG. 2 depicts a block diagram of a computer system which is capable of being used in connection with the system depicted in FIG. 1, in accordance with embodiments of the present invention;

FIG. 3 depicts a flowchart of a method of benchmarking, accounting, analysis, and cost forecasting utilizing an exemplary embodiment in accordance with embodiments of the present disclosure;

FIG. 4 depicts a flowchart of a method of harvesting, analyzing, indexing, organizing, and displaying data utilizing an exemplary embodiment in accordance with embodiments of the present;

FIG. 5 depicts a block diagram illustrating a system of benchmarking, accounting, analysis, and cost forecasting in accordance with embodiments of the present invention;

FIG. 6 depicts an exemplary client computer capable of being used with the system depicted in FIG. 1, in accordance with embodiments of the present invention;

FIG. 7 depicts a block diagram illustrating a system of benchmarking, accounting, analysis, and cost forecasting in accordance with embodiments of the present invention; and

FIG. 8 depicts an exemplary chart illustrating an exemplary method of coding data in accordance with embodiments of the present invention;

FIG. 9 depicts an exemplary spreadsheet illustrating various exemplary data types in accordance with embodiments of the present invention;

FIG. 10 depicts an exemplary logon interface in accordance with embodiments of the present invention;

FIG. 11 depicts an exemplary interface in accordance with embodiments of the present invention;

FIG. 12 depicts an exemplary interface in accordance with embodiments of the present invention;

FIG. 13 depicts an exemplary interface in accordance with embodiments of the present invention;

FIG. 14 depicts an exemplary interface in accordance with embodiments of the present invention;

FIG. 15 depicts an exemplary interface in accordance with embodiments of the present invention;

FIG. 16 depicts an exemplary interface in accordance with embodiments of the present invention;

FIG. 17 depicts an exemplary interface in accordance with embodiments of the present invention;

FIG. 18 depicts an exemplary interface in accordance with embodiments of the present invention;

FIG. 19 depicts an exemplary interface in accordance with embodiments of the present invention; and

FIG. 20 depicts an exemplary interface in accordance with embodiments of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to computer-implemented systems and methods for benchmarking, accounting, analysis, and cost forecasting. More specifically, embodiments of the present invention relate to computer-implemented systems and methods for benchmarking, accounting, analysis, and cost forecasting by providing a platform to help decision makers by coalescing data in a uniform format.

Embodiments of the present invention are adapted to capitalize on the vast universe of public data. This is made possible by harvesting, indexing, and then organizing public data into a single relational database system via exemplary embodiments of the present invention. Some embodiments comprise search and analytical tools to allow users to easily perform tasks and manipulate data in a logical, easy-to-understand fashion.

A system in accordance with the present disclosure may be adapted to code and organize data into municipalities, counties, states, or independent authorities or districts based on where the data belongs. A system may then be adapted to create or generate a profile page for each municipality, county, state, school district, authority, agency, and/or the like which provides one-click access to available data on that entity. An exemplary system may be adapted to enable users to slice and dice data in virtually limitless ways. Users may utilize the system to search and refine, generate rankings, graphs, comparisons, and much more through the use of analytical software tools, or the like.

In exemplary embodiments a system of organization may be provided that is both innovative and incredibly important because it may organize data based on how people logically think about government, or the like. A system may be adapted to utilize a specialized process for relating data collected from various sources. At the center a data structure system in accordance with exemplary embodiments may be the municipality. An exemplary system may be adapted to utilize a custom coding system to organize and relate datasets to each other.

Exemplary embodiments of the present invention may be built upon a template system. A template system may comprise a contextual layer of data that is required for valid analysis and may comprise, for example, current and previous years' budgets, contract terms and information, relevant policy, and tax implications, and/or the like. In some embodiments, users may be able to view combinations of the following features based on level of subscription: a tear sheet comprising a standardized printable and/or downloadable report that accurately portrays the municipality's fiscal state at that moment; suggested future scenarios based on accepted trends and forecasts; potential solutions to create a balanced budget, which may comprise projected savings for common cost-cutting measures including: joint court, best price insurance, regionalized police coverage, best pricing in bulk purchases, regionalized back office; and/or policy advice, which may comprise narrative reports on current and future policy scenarios such as tax rates, spending caps, etc. In some embodiments, a system in accordance with exemplary embodiments may comprise forecasting tools to allow municipalities to assess the possibilities and impacts of various scenarios on their budgets, or the like.

In some embodiments of the present invention, a system may comprise a tiered, variable-cost revenue model, or the like. A system in accordance with exemplary embodiments may be adapted to identify cost savings in municipal budgets and create impetus for cost-saving measures. Depending upon the municipality, an exemplary system may be adapted to provide budget review and analysis services on either an hourly fee-for-service basis, or with a flat, upfront fee and a percentage of the municipality's total cost savings at the close of the project.

A system in accordance with exemplary embodiments may be adapted to provide town statistics, for example, a 5-year actual budget history; graphical trends; key metrics; and/or the like. In some embodiments, a system may be adapted to comprise town statistics benchmarked against peer group of towns, for example, a 5 year actual budget history; graphical trends; key metrics. An exemplary system may also be adapted to provide town pension liabilities, for example, yearly pension costs for various pension plans (police, fireman, municipal); pension costs under various scenarios (optimistic, average, pessimistic); pension costs by year for 10 years; pension lump sum for 11 to 20 years; total pension liability under various scenarios (optimist, average, pessimistic); pension lump sum for yrs. 1-20; and/or the like.

In some embodiments, a system in accordance with exemplary embodiments may be adapted to calculate and/or provide town pension income. For example, a system in accordance with embodiments of the present invention may be adapted to provide a yearly pension income from town; employee, earnings for various pension plans (police, fireman, municipal); earnings under various scenarios (optimistic, average, pessimistic); earnings by year for 10 years; lump sum for 11 to 20th. year; total pension income under various scenarios (optimist, average, pessimistic); and/or the like. In some embodiments, a system in accordance with the present invention may be adapted to calculate and/or provide other town income and expenses, or the like. For example, a system may be adapted to provide 5 year forecasts for other major budget items. An exemplary system may also be adapted to utilize the 80/20 rule to choose the key items; to provide other town income under various scenarios (optimistic, average and pessimistic); and/or the like.

In exemplary embodiments, a system may be adapted to provide a multiyear operating budget analysis comprising a yearly budget for next 5 years combining forecasts from other portions of the system, and/or the like. A system may also be adapted to provide a multiyear capital budget analysis comprising a yearly capital budget for next 5 years combining forecasts from other portions of the system, and/or the like. A system may also be adapted to provide a multiyear economic analysis and a key metrics analysis comprising a debt/equity analysis; a cash flow analysis; and/or the like based on data from other portions of the system, or the like. In some embodiments, the system may provide a dashboard for key metrics and/or a multiyear economic analysis comprising decision hot spots that identify key positive and negative metrics and tends, and/or the like.

A system in accordance with exemplary embodiments of the present invention may comprise a suite of products that may provide a complete financial data platform that may allow governments and interested parties to assess the financial impact of policy and market changes on municipal debt, budgets, and operations, or the like. A system may also provide a comparison tool, allowing users to evaluate differences between towns and find opportunities to reduce taxes or improve services. An exemplary system may create a smart, extensible, and flexible method to deliver expert insight and analysis to governments and citizens who would not otherwise be able to access or develop advanced financial data, analytics and forecasting on their own.

In accordance with certain embodiments of the present disclosure, some methods disclosed herein may occur in “real-time.” Real-time is utilized herein as meaning near-instantaneous, subject to minor delays caused by network transmission and computer processing functions, and able to support various input and output data streams.

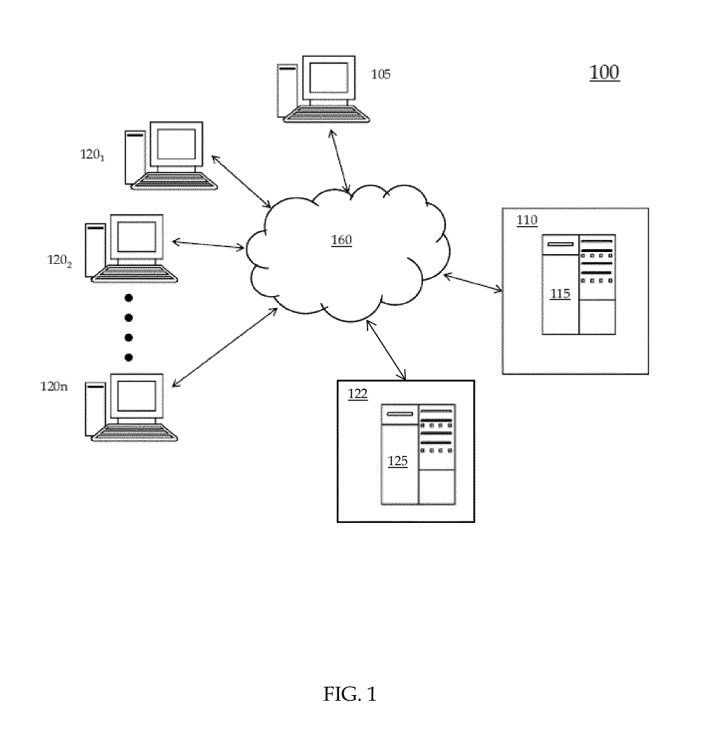

FIG. 1 depicts a system-level network diagram of system of a benchmarking, accounting, analysis, and cost forecasting system in accordance with one embodiment of the present disclosure. The system 100 generally comprises at least a first user 105 and secondary users 120₁ and 120₂, each in communication with an administrator 110, generally hosting a central server 115 or database, through a network 160, which may comprise a global computer network, for example, the Internet.

As is common in network-based business models, the administrator 110 may also comprise a web administrator, responsible for providing and maintaining a website or interactive portal through which all of the users of the system 100 may interact and execute the methodology and functionality disclosed in the embodiments disclosed herein.

Although FIG. 1 explicitly depicts three secondary users (120₁, 120₂, and 120ₙ), it should be appreciated that “n” represents any number of users feasible in accordance with embodiments of the present disclosure. For ease of reference, as used herein, each of the terms “second user” or “secondary user” may refer to any one or all of the users 120₁, 120₂, and 120_{N} within the system 100. Likewise, although FIG. 1 explicitly depicts only one first user 105, there may be more than one first user 105 in accordance with certain embodiments of the present disclosure. That is, in certain embodiments, multiple users may perform the same or similar functions as the first user 105. As understood by embodiments of the present disclosure, a user may include any person or entity capable of participating in the system and methods disclosed herein.

The first user 105 generally comprises a decision maker that seeks to view, manipulate, and/or display relevant data and receive benchmarking, accounting, analysis, and cost forecasting services. The data may be related to one or more private or public entities. For example, the data may be related to a particular municipality. Some examples of data categories may comprise: a Department of Community Affairs (“DCA”) municipal (“muni”) code; municipality; county; year; population; area in square miles; population density per square mile; mean income of top 5%; mean income of top quintile; mean income of 2nd quintile; mean income (3rd quintile); mean income of 4th quintile; mean income of bottom quintile; index crimes; index crime rate per 1,000 population; violent crime; violent crime rate per 1,000 population; police employees; index crime rate per police officer; police budget; police protection cost per resident; uniformed employees; median uniformed salary; top uniformed salary; non-uniformed employees; median non-uniformed salary; top non-uniformed salary; total property value; average residential property value; average residential property tax bill; average state property tax rebate; average net residential property tax bill; total property taxes; school property tax; municipal property tax (including open space and library tax); county property tax (including open space tax); total government (property tax) cost per person; school tax as percentage of total property tax; municipal tax as percentage of total property tax; county tax as percentage of total property tax; school cost per person; municipal government property tax cost per person; county government property tax cost per person; state aid to municipal government; state aid to schools; state aid to county government; total state aid; state aid per person; total property value; total residential property value; residential percentage of total value; apartment value; apartment value as percentage of total value; farm value (included in residential value); farm percentage of total value; industrial property value; industrial percentage of total value; commercial property value; commercial percentage of total value; vacant land value; vacant land percentage; labor force; employed; unemployed; percent unemployed; number of private firms in municipality; private sector employees (annual average); total private sector payroll; average private sector annual wages; total public sector employees; total local government and school employees; local government employees; local government school employees; state government employees; federal government employees; local government and school payroll; local government payroll; local school payroll; state government payroll; federal government payroll; average local government and school employee wages; average local government annual wages; average school employee wages; average state government wages; average federal employee wages; ethnicity; percentages of ethnicity; whites; percentage whites; blacks; percentage blacks; Hispanics; percentage Hispanics; Asians; percentage Asians; pacific islanders; percentage pacific islanders; American Indians and Alaska natives; percentage American Indians and Alaska natives; other; percentage other; 18 and older; percentage 18 and older; and/or the like.

In exemplary embodiments of the present invention, a system and/or method may be adapted to provide benchmarking, accounting, analysis, and cost forecasting by providing a proprietary suite of software tools to help decision makers by coalescing relevant data in a uniform format. The system/method may comprise a cloud-based SaaS software suite exists on top of a relational database of relevant data, sourced from either publicly available sources and/or provided on a private basis. The system/and or method may comprise a set of computer executable instructions and/or software (hereinafter, the “platform”) that may be configured to integrate a primary layer of analytical, benchmarking, and graphical tools, a secondary layer of forecasting and modeling capabilities, and a tertiary layer of multi-year budgeting and planning tools based on the primary and secondary layers. In accordance with exemplary embodiments, a revenue model for the platform may comprise providing the platform as software as a service with the potential for renewal.

The platform may generally be adapted to allow a user to utilize data and analytics that may result in current and future cost savings and improved long-term financial planning for the user. The platform may be further adapted to streamline financial operation, enhance financial and investment strategies, and narrow risks. In some embodiments, the platform may also be adapted to utilize future cost projection algorithms, for example, related to both pensions and health benefits, to be able to circle back and deliver a bottom line number on what it actually costs to hire an additional person, or “person X.” This concept may be referred to in the platform as fully-loaded costing. In some embodiments, the functionality of the platform may be divided and performed by multiple users, platforms, software modules, entities, and/or the like.

The platform may be adapted to bring together complicated financial statements and relevant data (that was previously un-usable) in a user friendly interface and offer the ability to compare and benchmark municipalities against each other. The platform may also be adapted to calculate the future pension liability for each client and the future employee and retiree health benefit liability for each client, while taking into account different economic growth scenarios and asset returns in order to provide an accurate projection. The platform may also be adapted to allow municipalities to construct their own multi-year operating and capital budget that takes into account their pension and healthcare liabilities.

The platform may comprise one or more modules. The modules may comprise: a database, such as a SQLite or MySQL Database comprising national, state, county, and/or municipal data or the like; GovOutlook suite; a statistics analytical platform; a forecasting and budgeting platform; a credit outlook suite; a credit analytical and forecasting platform; credit algorithms; and credit profiles. In accordance with exemplary embodiments, the platform may be adapted to analyze, understand, and chart an entity's fiscal path forward. In one example embodiment, the entity may be a governmental entity. The platform may also be adapted to allow au user to see government/entity data in one place, analyze the situation, compare it with others, and get near-immediate answers on future pension and healthcare costs. The platform may be adapted to provide relevant data, benchmarking, substantially instant calculations of future costs, multi-year budgets, and may automatically comply with GASB accounting requirements.

In exemplary embodiments, the platform may further be adapted to provide, calculate, and/or analyze instant, detailed municipal credit profiles that include unfunded liabilities. The platform may be adapted to allow a user to see economic vitality and ability-to-pay data in one place, easily compare it, and get complete credit profiles that include unfunded pension and health benefits liabilities. The platform may be adapted to retrieve, calculate, and/or provide economic data and trends; to provide an entity/municipality's future liabilities; and to provide calculations in a GASB compliant and peer-reviewed format. In exemplary embodiments, the systems/methods/platforms/modules in accordance with the present invention may be configured for use with various entities, such as municipalities, county governments, municipal credit stakeholders, and private entities, or the like.

In accordance with exemplary embodiments, the platform may comprise a process of joining disparate databases from primarily public sources and then “coding” them in a consistent format using a data identifier, such as a 9-column or more data identifier, which assigns unique codes to each municipality, county, school district, state government, etc. in a hierarchical fashion. In some embodiments, the platform may have data pre-loaded in a consistent format and may be configured to provide a “turn-key” product for potential users, for example, a second user. In exemplary embodiments, it may not be necessary to receive information, such as a municipal budget or other financial document, from a second user, or the like. Rather, the platform may be configured to comprise pre-loaded data in a consistent format on a widespread basis (i.e. for markets the platform is currently operating in). However, additional information may be required on behalf of a second user, or the like, in order for a secondary software layer and related algorithms of the platform to generate a valid future liability forecast.

In some exemplary embodiments, the platform may be configured to provide a “User-Friendly Budget” format, which may be adopted by entities as a standard format that allows lengthy page municipal budgets that potentially contain hundreds if not thousands of individual line items to be simplified into roughly easy-to-understand categories. The platform may be configured to complete a process of subtotaling complicated government documents (particularly municipal budgets) into user-friendly, uniform, and agreed upon categories for the purposes of comparison in a commercial application. In some embodiments, data related to entities, such as municipalities may be stored in a relational database, coded in a standard format, and presented to a municipality in a user-friendly graphical format. In some embodiments, data may be presented in a graphical format similar to a tear sheet, or a one page summary of relevant data and analysis for a particular entity. As such, the platform may provide municipalities a way to compare the data related to other municipalities in a region, such as a county or state.

The platform may also be configured to provide analysis of pension liability and health benefits liability, including the forward cost of current and potential new employees. The platforms in accordance with embodiments of the present invention may allow for responsible multiyear budgeting and fully allocated costs over time, which may comprise a real assessment of forward costs utilizing historical data. In some embodiments, the platform may be adapted to perform a credit analysis based on the data consistent with exemplary embodiments of the present invention, and may provide a “right track” or “wrong track” indicator. These indicators may be configured to indicate, as a result of analysis of the data consistent with the present invention, whether a municipality is on a path toward prosperity. In some embodiments, the system may be adapted to display a predetermined color associated with a “right track” or “wrong track” determination, such as green and red, respectively, or the like.

In exemplary embodiments, the platform may be configured to take raw and un-manipulated data and create “derived” data categories that provide new perspectives on the same dataset. By way of example, the creation of derived data categories may include doing “per person” calculations, percentages, or the like that do not come as a part of the original data. Additionally, in some embodiments, taking complicated data and presenting it in a simple GUI may provide further value by allowing technically unsophisticated users the ability to draw conclusions and answer questions through a simple graphical interface. In some embodiments, the platform may be configured to sub-total specific line items into logical and easy-to-understand categories and then apply an intuitive and attractive interface. The platform may also be configured to provide a user the ability to then “drill down” into a given category and see more advanced data and information. The platform may also be configured to allow advanced users, or users with advanced technical or analytical skill sets, the ability to see the specific line items that were totaled by the platform in order to conclude at a given number.

The platform may also be configured to provide firms, governments, and/or other interested parties access to the platform for the purpose of credit analysis. Given the fact that most major credit rating agencies currently only utilize a “checklist” approach to assigning ratings, the platform may be configured to provide a more thorough approach that includes variables and critical information quantified through algorithms such as operations data, computed future pension liabilities, computed future health benefits liabilities, results of generated multi-year budget analyses, or the like, to derive higher quality and more accurate and precise credit ratings. The platform may also be configured to make adjustments to forecasting algorithms and models following policy changes such as the Patient Protection and Affordable Care Act or GASB's new accounting principles that will be tightening and changing upward (i.e. calculations will be higher) the way pension liabilities are calculated. In exemplary embodiments, secondary user(s) 120 may include one or more individuals, groups, or entities that may be provided access to at least a portion of the data and/or GUIs that may be provided by the platform. In some embodiment, a secondary user may comprise a client of an entity administering access to the platform.

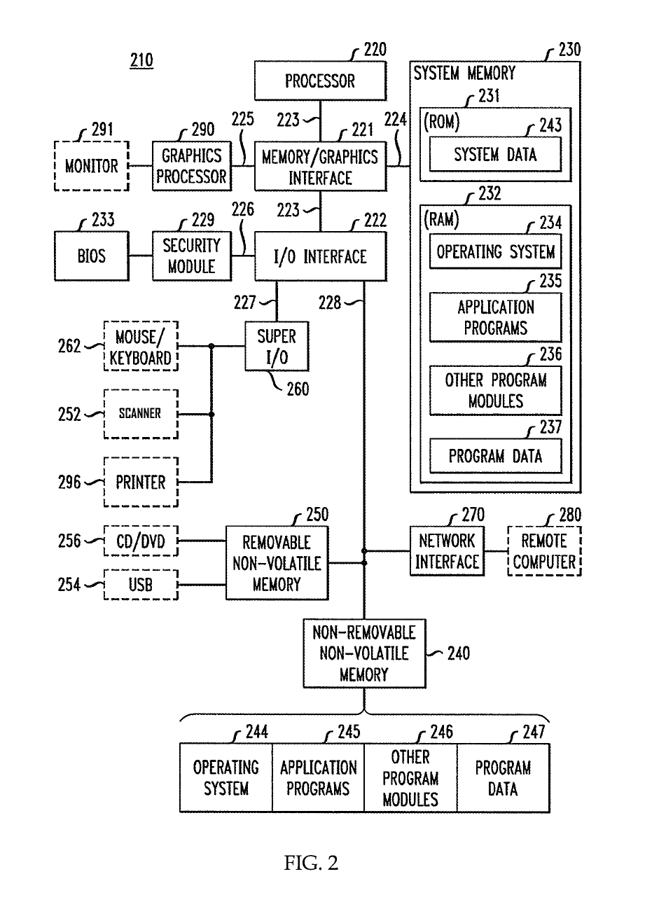

In a basic exemplary embodiment, within the system 100, a first user 105 may request access to access the platform, using a computing device. The administrator 110 may then approve or deny the access request. In some embodiments, the first user 105 may access the platform without the approval of an administrator 110. The computing device in the context of this application may include, but is not limited to a mobile device, a personal computer, a desktop computer, a notebook/laptop computer, a server computer, an enterprise server, a supercomputer, a wearable computer, computer clothing, a smart watch, a cellular telephone, a smartphone, Personal Data Assistant (PDA), a netbook, a mobile computer, a workstation, a tablet computer, and/or the like, or may generally include a general purpose computer, or components thereof as discussed below in FIG. 2.

The network 160 may comprise any network suitable for embodiments of the present disclosure. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, an 802.11 (“Wi-Fi”) protocol, cellular data protocol (e.g., CDMA, TDMA, LTE), core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; local area networks (LANs), wide area networks (WANs), metropolitan area networks (MANs), storage area networks (SANs), peer-to-peer networks, and/or communication links, such as Universal Serial Bus (USB) links; parallel port links, Firewire links, RS-232 links, RS-485 links, Controller-Area Network (CAN) links, and the like. A single network 160 or multiple networks (not shown) that are communicatively coupled to one another can be used. It is contemplated that multiple networks of varying types can be connected together and utilized to facilitate the communications contemplated by the systems and elements described in this disclosure.

Optionally, a third party 122, generally hosting a server 125 or database, may be in communication with the system 100 through the network 160 to carry out certain features of embodiments of the present disclosure, as explained below. In accordance with embodiments of the present disclosure, such third party servers 125 may be administered by government entities, private entities, financial institutions (e.g., banks, credit card companies, or the like), advertisers (e.g., any third party offering banner ads or displayed offers), local merchants (e.g., providing information regarding an area or services within an area), social networking sites (e.g., Facebook, MySpace, Twitter, FourSquare or the like), global positioning system administrators, or the like.

In accordance with one embodiment of the present disclosure, any of the administrator or users may comprise a general purpose computer, for example, as shown in the form of a computer 210 depicted in FIG. 2. As appreciated by embodiments of the present disclosure, more practical devices, such as mobile devices, mobile telephones, laptop computers, netbooks, tablet computers, those devices identified supra, or the like, are likely to be utilized than a general computer 210 for embodiments of the present disclosure. However, it is also appreciated there is a significant similarly in core components between a mobile device, a personal computer, and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210.

The term communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein. A super input/output chip 260 may be used to connect to a number of peripherals, such as scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, touch screen, fax machine, modem, touch pad, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet. In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present disclosure, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure. Further, but other commonly known, components for mobile devices and personal computers may also be included in a general computer 210. For example, global positioning chips, wireless communication capability, and related technologies should be included within many embodiments of the present disclosure.

It is understood by embodiments of the present disclosure that a computer, such as the one depicted in FIG. 2, may be connected to a computer network or system. A computer network may include the Internet, a global computer network, a global positioning system, an internal computer network, dedicated server networks, or the like.

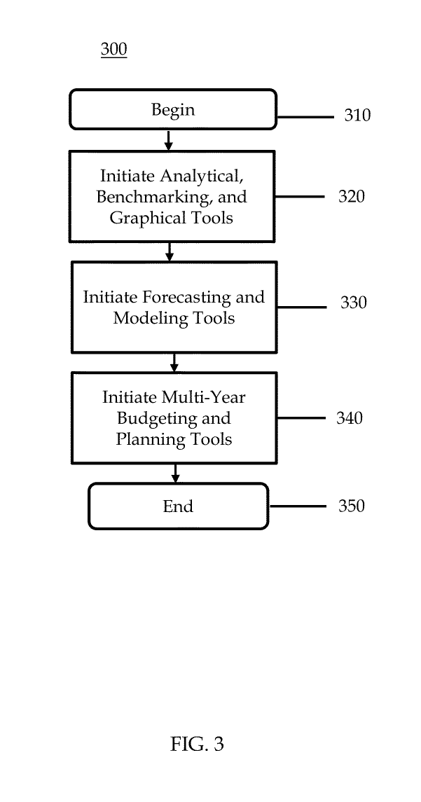

FIG. 3 depicts a flowchart of a method of benchmarking, accounting, analysis, and cost forecasting utilizing an exemplary embodiment in accordance with embodiments of the present disclosure. The method 300 begins as step 310, wherein a computing device having one or more processors and memory storing one or more programs for execution by the one or more processors may be adapted to perform functionality in accordance with the present disclosure. It is contemplated that more than one step described may be performed simultaneously or partially simultaneously with other steps.

At step 320, analytical, benchmarking, and/or graphical tools in accordance with the present invention by be initiated by a user. The user may comprise an individual or computing device provided access to the platform. In some embodiments, the platform may comprise a cloud-based software as a service (“SaaS”) software suite existing on top of a relational database of relevant data, sourced from either publicly available sources or provided on a private basis. The platform may be adapted to integrate a primary layer of analytical, benchmarking, and graphical tools.

The platform may be adapted to perform a process of joining disparate databases from primarily public sources and then “coding” them in a consistent format using one or more data identifiers that assign unique codes to each municipality, county, school district, state government, etc. in a hierarchical fashion. Having data pre-loaded in a consistent format may provide a “turn-key” product for users.

At step 330, the user and/or a system may initiate a forecasting and modeling tool. Additional information may be received behalf of a user in order for a secondary software layer and related algorithms to generate a valid future liability forecast. At step 340, a multi-year budgeting and planning tool may be initiated by a user. A platform in accordance with the present invention may be adapted provide multi-year budgeting based on fully-allocated costs over time.

In some embodiments a platform may be adapted to transform complicated government documents (particularly municipal budgets) into user-friendly, uniform, and agreed upon categories for the purposes of comparison in a commercial application. The exemplary method 300 may end at step 350.

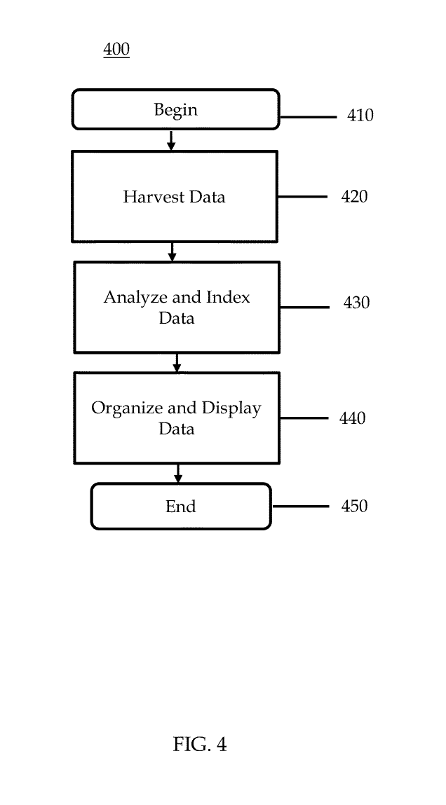

FIG. 4 depicts a flowchart of a method of harvesting, analyzing, indexing, organizing, and displaying data utilizing an exemplary embodiment in accordance with embodiments of the present disclosure. The method 400 begins as step 410, wherein a computing device having one or more processors and memory storing one or more programs for execution by the one or more processors may be adapted to perform functionality in accordance with the present disclosure. It is contemplated that more than one step described may be performed simultaneously or partially simultaneously with other steps.

At step 420, data may be harvested and/or collected by the system. In some embodiments, the data may be harvested by accessing public data sources and/or private data sources and retrieving data relevant to the system. For example, data may be harvested from a collection of municipal databases, may be manually input into the system, may be received from an uploaded file, and/or may be retrieved from a private database via a user account with the private database, and/or the like. At step 430, the data may be analyzed by the system and categorized. Each piece of data may then be coted using the coding systems described herein, or the like. After each piece of data is coded the data may be organized and displayed to the user in a coherent display to assist the decision-making of the user at step 440. At step 440, a profile may be generated and displayed to a user via a display device as described herein. The user may access the display and may also access the functionality of the system via the display/interface as described herein. After the user has received the requested data, the method ends at step 450, or the like.

In addition to the exemplary methods shown, embodiments of the present disclosure may have numerous additional features. For example, in one embodiment, the system may be adapted to allow messaging between users. The system may be adapted to allow anonymous and non-anonymous messaging, grouping, and communication among users and/or groups of users, whether registered to the system or not registered. In some embodiments, the communications may occur within discussion groups and communities. In alternative embodiments, the communications may take place outside discussion groups and communities, for example, via direct messaging.

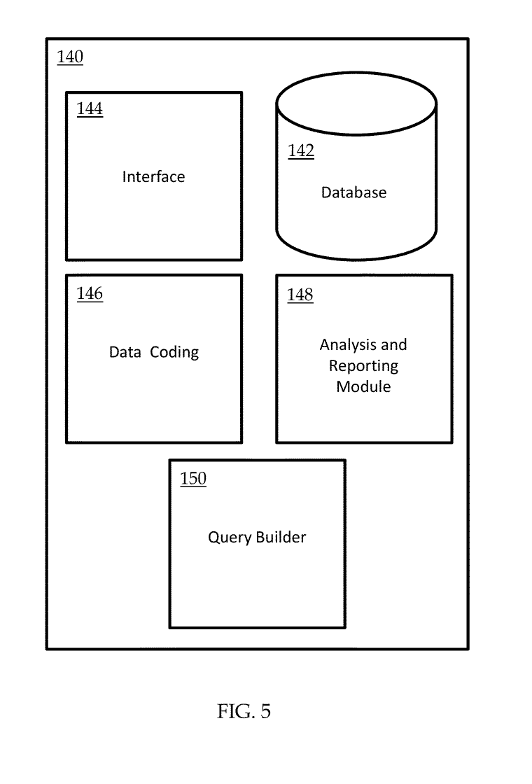

FIG. 5 depicts a block diagram illustrating a system of benchmarking, accounting, analysis, and cost forecasting 140 in accordance with embodiments of the present invention. A system 140 may generally comprise computer executable software and/or instructions configured to perform the functionality of the systems and methods disclosed herein. The system 140 may be stored on a server, on a local computing device, on a mobile communications device, and/or the like. The system 140 may comprise a database 142, an interface module 144, a data coding module 146, an analysis and reporting module 148, and/or the like. In accordance with exemplary embodiments of the present invention, any module may be merged and/or combined with any other module. In some embodiments, additional or fewer modules than those depicted in FIG. 5 may be included.

In exemplary embodiments, the system 140 may be configured to retrieve data, analyze data, generate forecasts, and display the data in a coherent display in accordance with user preferences. The system 140 may be adapted to display or transmit information to one or more users, receive public data from the one or more users, analyze public data, store at least a portion of the public data and/or the analysis, and present a report to an administrator and/or user, or the like. In some embodiments, the system 140 may be configured to provide real-time or substantially real-time public and/or private data to users upon request, at predetermined intervals, and/or the like. In exemplary embodiments, the term “user” may generally refer to any party provided with access to the systems and methods in accordance with embodiments of the present invention. For example, a user may comprise a member of the public, a financial professional, a government employee, a policy expert, and/or the like.

In exemplary embodiments, the interface module 144 may be adapted to provide the user with a means for interacting with the system 140. The interface module 144 may be adapted to present a graphical user interface (GUI) to the user, the GUI adapted to allow users to input, view, and interact with the system 140. In some embodiments, the interface module 144 may be adapted to present public or private information to a user via a display on a computer, a tablet, a mobile device, a laptop, a touchscreen device, and/or the like. The interface module 144 may also be adapted to provide an opportunity to register a user account for accessing the system 140.

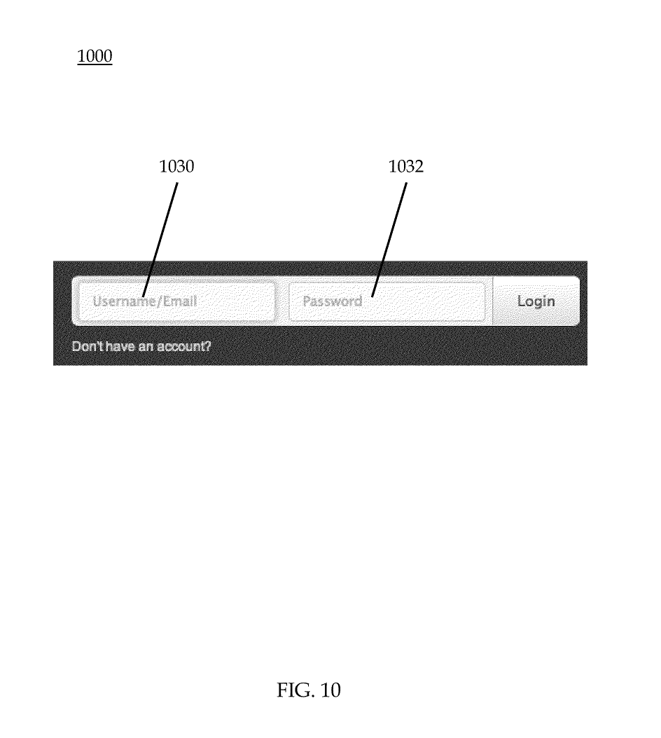

For example, as shown in FIG. 10, the interface module may present a login interface 1000 comprising a username interface 1030 and a password interface 1032, and/or the like. User accounts may be restricted to authorized personnel and a verification of a user's identity, such as a social security number or a government ID number, may be required. In some embodiments, a user may gain access to the system via the login interface 1000 by entering a correct username and/or password in the username interface 1030 and the password interface 1032 and/or the like. In some embodiments, additional security measures, such as biometric security measures, may be implemented.

In some embodiments, a user may create a user profile that may comprise information about the user. For example, a user profile may comprise a user ID, a name, a company, an e-mail address, a phone number, a mailing address, contact information, an account status, an original registration date or year, an indication of the last login, a profile photo, an associated entity or municipality, a preferred time zone, login credentials, billing details, an account type, a license type, and/or the like. In some embodiments. A user's profile may be searchable and/or accessible by other users, administrators, entities, and/or the like.

Referring back to FIG. 5, in some embodiments, user account requests must be approved by an administrator of the system 140 and/or may only be created by an administrator. The interface module 144 may be adapted to allow a user to run a search query on data stored in the database 142. The interface module 144 may be adapted to allow the user to run a report on the data contained in the database 142 with the analysis and reporting module 148 upon request, or the like. For example, a user may access data upon running a report request with the interface module 144.

In exemplary embodiments, the data coding module 146 may be adapted to harvest, code, index, organize, and/or the like public and/or private data received by the system 140, or the like. In accordance with exemplary embodiments of the present invention, the data coding module 146 may be adapted to receive data from a device, such as a computing device or mobile communications device, and/or the like. In exemplary embodiments, public data may comprise real-time data regarding the municipalities and/or the like. In some embodiments, public data may comprise the data described above. In some embodiments, if the public and/or private data may be transmitted to the analysis and reporting module 148. In accordance with exemplary embodiments, the database 142 may be adapted to store all public and/or private data in accordance with the present invention.

In exemplary embodiments, the data coding module 146 may be adapted to provide data coding and organization of data, or the like. The coding module 146 may utilize a specialized process for relating data collected from various sources. At the core of the system 140 may be the municipality, which is generally the lowest and most local layer of government. Virtually all data in the system 140 is coded by the data coding module 146 in a way that relates it back to this level of government. The data coding module 146 may utilize a custom coding system to organize and relate datasets to each other.

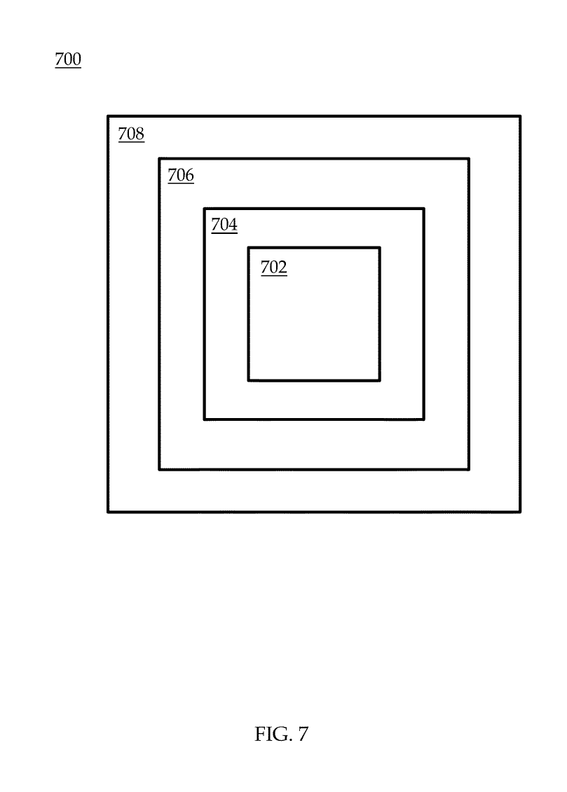

FIG. 7 depicts a block diagram illustrating a system 700 of benchmarking, accounting, analysis, and cost forecasting in accordance with embodiments of the present invention. As illustrated in FIG. 7, the core data indicator is the municipality 702, which is in a sense a parent to the associated data categories such as county 704, state 706, country 708, and/or the like. Other examples of data categories are described above, and may include congressional district, school district, customized district (e.g., Northern New Jersey, Southern New Jersey); and/or the like. In exemplary embodiments each data category can be customized by the administrator and/or the user.

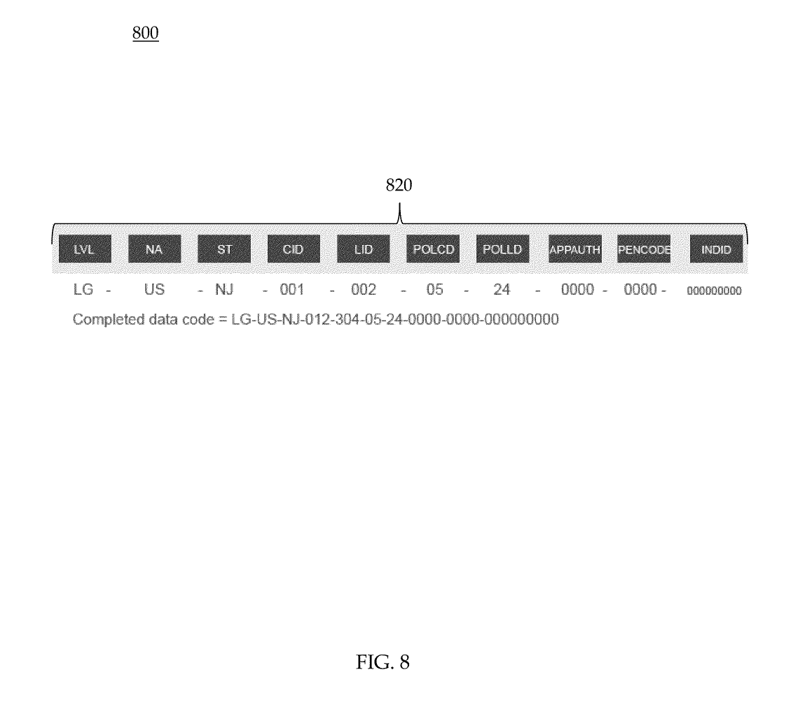

FIG. 8 depicts a sample structure illustrated with an exemplary chart illustrating an exemplary method of coding data via the system 140. In exemplary embodiments, each piece of data is coded in accordance with various codes 820 to form a completed data code. In the example depicted in FIG. 8, the completed data code is LG-US-NG-012-304-05-24-0000-0000-000000000. Each portion of the code is used to indicate a different identifying feature of the data. For example, the code referenced above indicates this is a local government data point in the U.S. state of New Jersey in Atlantic County for the municipality of Absecon in congressional district 2 and legislative district 2. In this example, the appointing authority code, pension code, and individual ID are null (all zeros) because they do not apply to this particular piece of data.

Referring back to FIG. 5, coding harvested data so that it relates back to municipalities with the data coding module 146 may allow the system 140 to create county, state, and federal, or the like, numbers based on aggregating data to the next subsequently higher level of government that overlays a municipality as illustrated in FIG. 7. For example: Data point X belongs to Municipality A. Municipality A is within B County, and B County is within C State. Therefore, all of the data points related to Municipality A are children of B County and C State. Applicable data points from School District D or Local Authority E are related to Municipality A or multiple municipalities in the case of regional school districts or authorities. Data from Municipality A is also sorted into Congressional District F and Legislative District G.

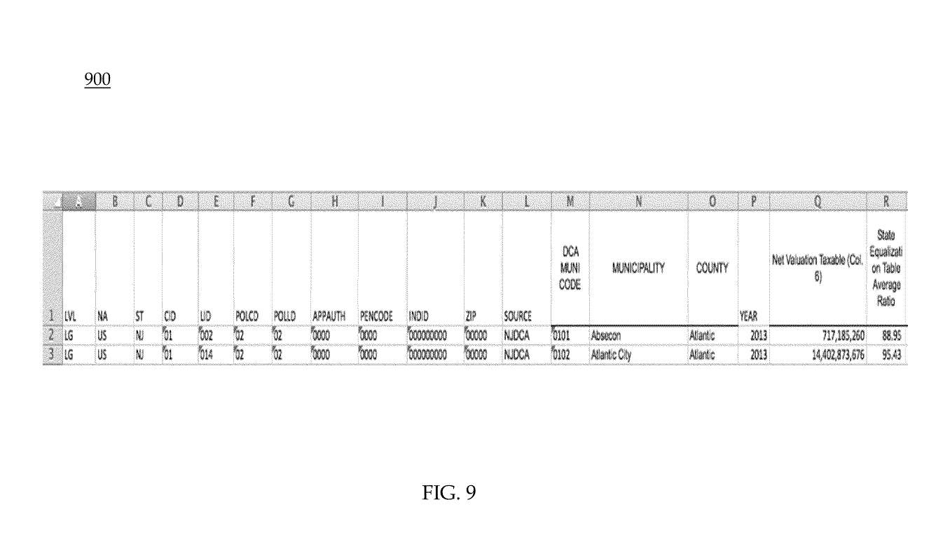

FIG. 9 depicts an exemplary coded spreadsheet 900 illustrating various exemplary data types in accordance with embodiments of the present invention. In exemplary embodiments a coded spreadsheet 900 may be provided and/or generated by the system, where, for example, columns A-J represent the system's unique data code, columns K-P represent additional identifiers, and Q and R represent data categories, or the like. The coded spreadsheet 900 illustrated in FIG. 9 is for exemplary purposes only. It is contemplated by and within embodiments of the present invention that different data categories, types, and/or indicators as described herein may be used instead and/or may be customized by a user and/or an administrator, or the like.

Referring back to FIG. 5, the system 140 may comprise a relational database 142, or the like. In some embodiments, coded and harvested data may be imported into a cluster of databases 142, such as SQLite databases, or the like, that reference each other. These database clusters 142 may exist and be stored on a single high-powered server array but may also be stored on a cloud based solution, or the like, to maximize performance. In some embodiments, JavaScript Object Notification (“JSON”) files may be used to define the database structure. Each JSON file may represent a single database, which can contain any number of tables, or the like.

In exemplary embodiments, a set of database management classes may be used by the data coding module 146 to abstract the process of reading and writing with underlying SQLite databases 142, or the like. Each table may be automatically given or assigned a “rowid”, “modified”, “modified-by”, “created”, and “created-by” column that may be managed by the underlying abstraction layer. Therefore, database 142 may be capable of keeping track of who's modified or created what without any additional intervention when creating or updating rows, or the like.

Generally it is not a wise decision to keep data of possibly unknown size in a database 142, or the like. When dealing with large binary files, Geographic Information Systems (“GIS”) data, or the like, the bulk of the data may be stored in a separate location but referenced by the database 142, and only the metadata and cached searchables (in the case of GIS data, which entities like counties, municipalities, and so on intersect with the shapefile's data) are stored within the database itself, or the like. In some embodiments, the system 140 may provide each entity with its own table. For example, municipalities, counties, or the like, may each have their own table which may help improve database performance, or the like.

In some embodiments of the present invention, portions of the system 140 may exist on top of a database cluster 142 and may serve various functions. The functions may include, for example: (a) To provide users with the ability to view, analyze and manipulate centralized datasets quickly and easily in a user-friendly environment and/or (b) To generate canned or pre-structured reports that answer specific questions, collate specific data points, or run pre-determined analyses in order to solve issues specific to an industry or particular clientele, or the like.

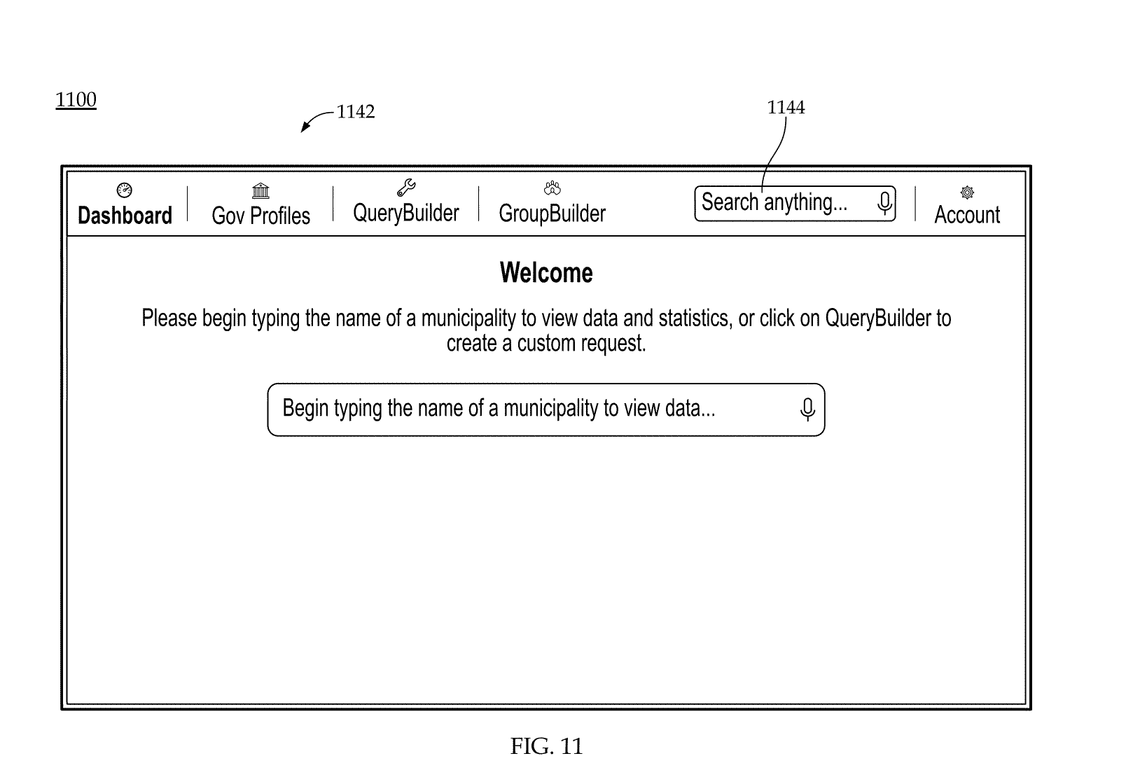

FIG. 11 depicts an exemplary interface 1100 in accordance with exemplary embodiments of the present invention. The interface 1100 may comprise various main options 1142 and may comprise the main display and interface for the user accessing the system, or the like. The main options 1142 may comprise a general dashboard for viewing data and accessing the system; a government profiles option for accessing the profile information described herein for a particular municipality, group of municipalities, or the like; a query builder option for accessing a Query Builder interface 150 described herein; and a group builder interface for selecting various members of a group thereby enabling a user to view data specific to and important to the selected group.

In some embodiments, the interface 1100 may also comprise a search interface 1144 for allowing a user to complete a search function and search at least a portion of the database 142 of the system. A system in accordance with some embodiments of the present invention may comprise multiple functions. A first of these functions may comprise search capability, which may allow users to search by name for any individual, municipality, district, county, state, authority, or the like. The search may be completed via the search interface 1144 and may also return results based on data source and other relevant keywords. Searching by name via the system 140 deliver a result in the form of a profile page, or the like. A profile page may display custom information to the user in a coherent display. The layout of this page may be optimized to deliver the most accessed and relevant data first. The profile may centralize data on a particular individual or governmental entity based on publicly available data from a database cluster 142, or the like.

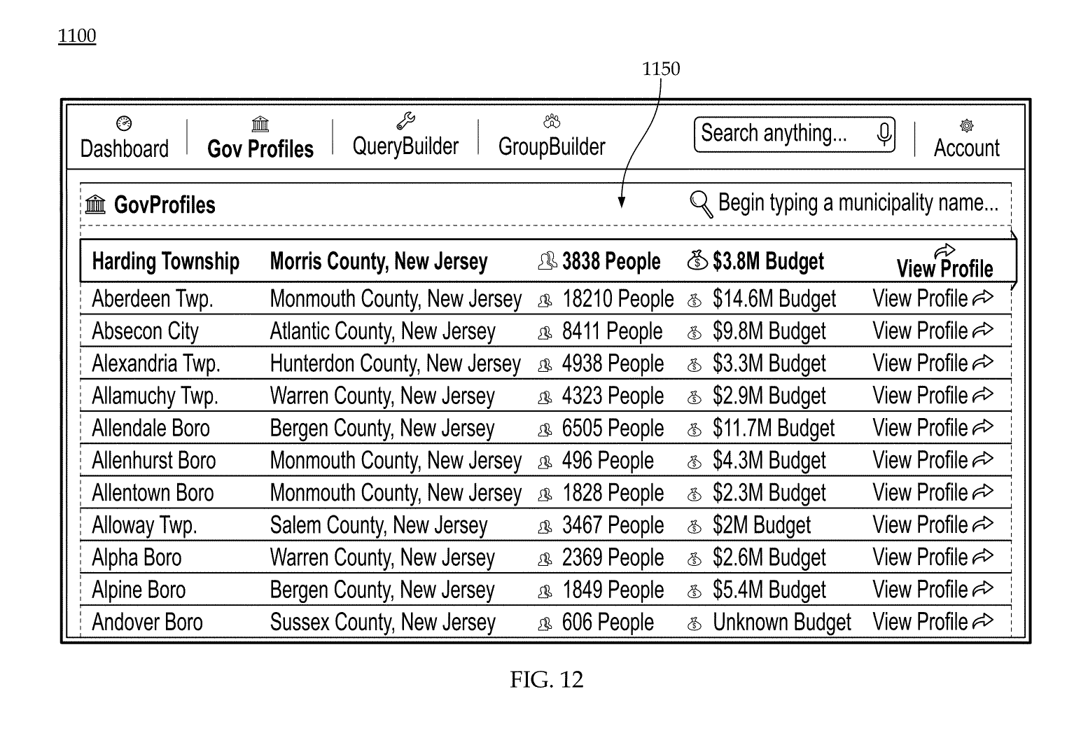

FIG. 12 depicts an exemplary interface 1100 in accordance with exemplary embodiments of the present invention. The interface 1100 in FIG. 12 depicts the government profile selection interface 1150 that may be displayed when the user selects the government profiles option, or the like. The government profile selection interface 1150 may display data relating to various municipalities, or the like. In some embodiments, the government profile selection interface 1150 may display a municipality name, a county, a population, an annual budget, a link to the government entity profile in the system, and/or the like. The data displayed via the government profile selection interface 1150 may be customized by the user and/or an administrator and may comprise any data types consistent with the present disclosure.

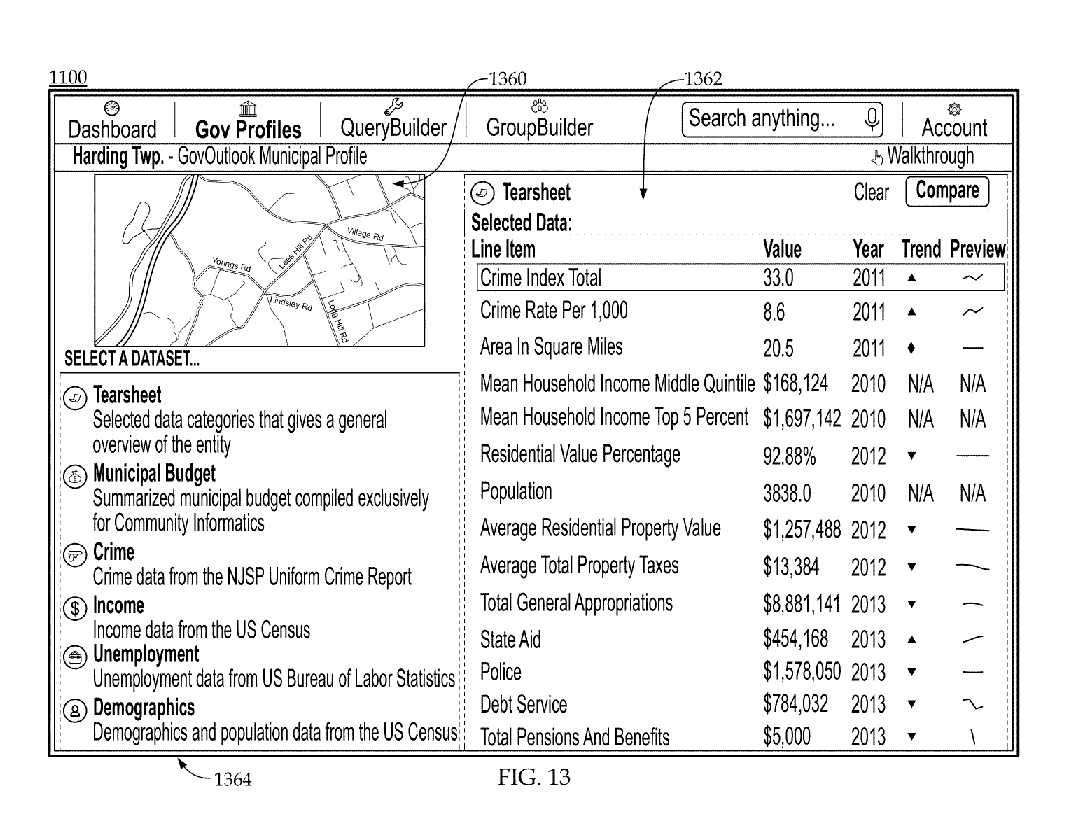

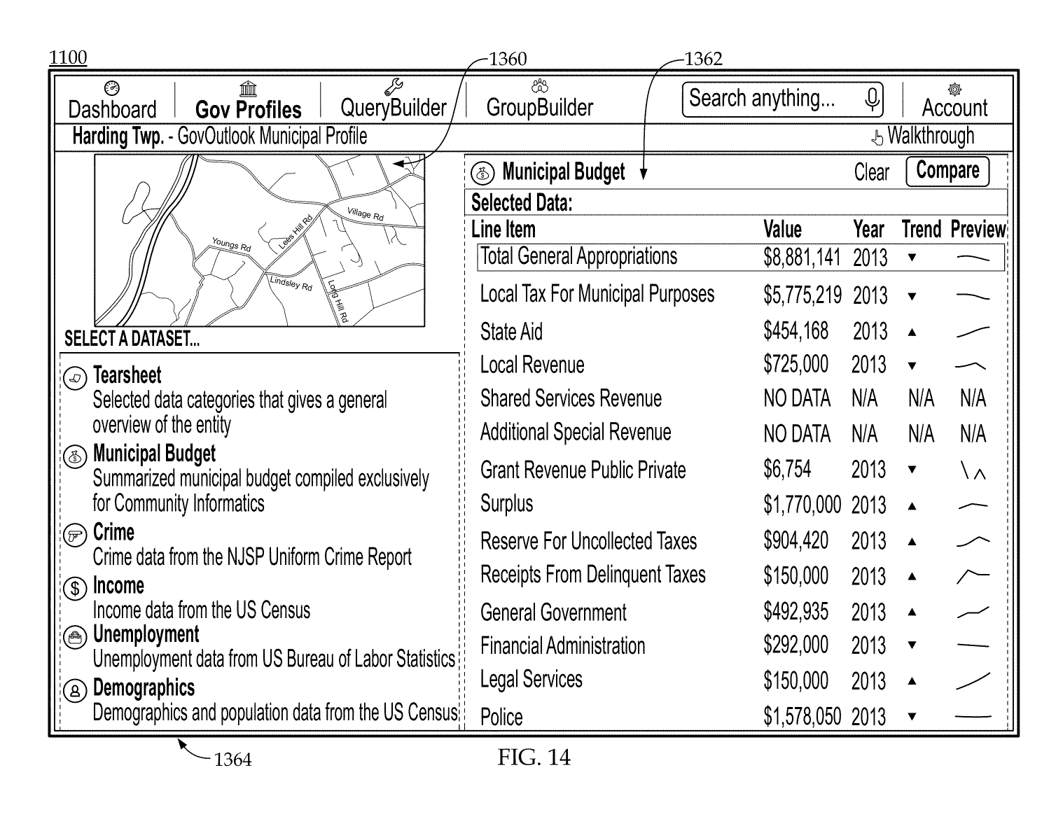

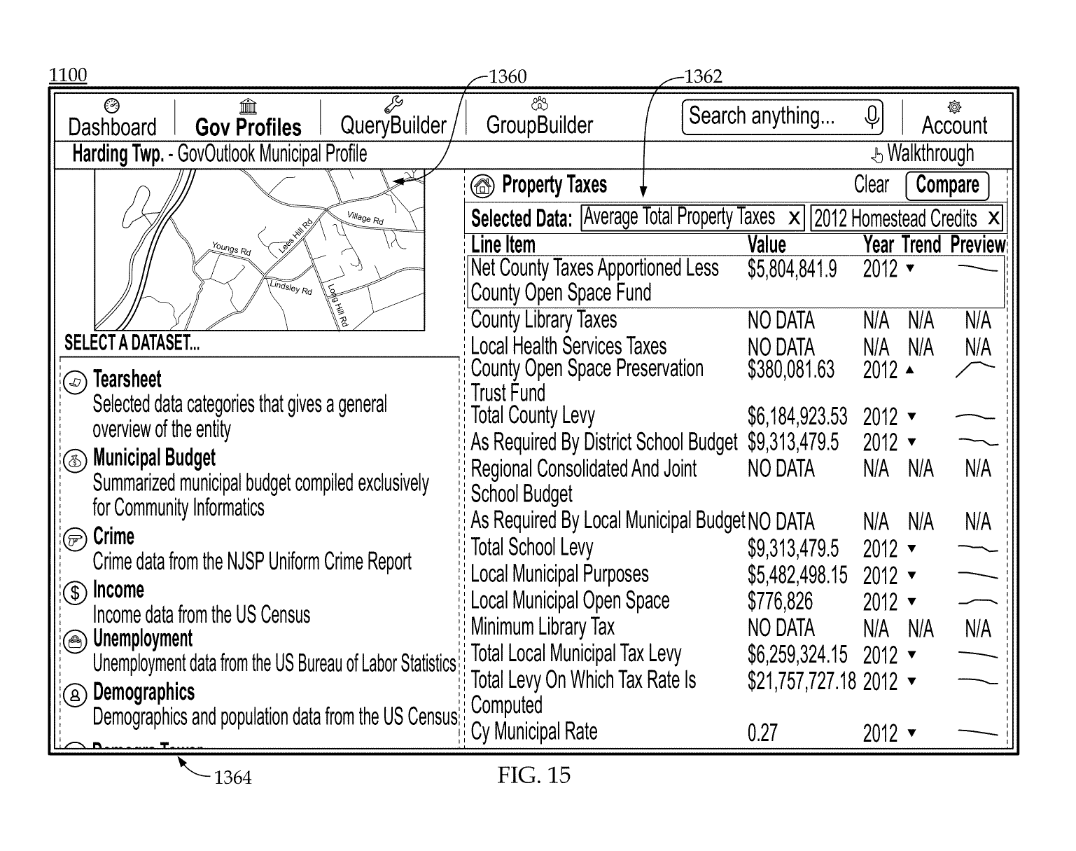

FIG. 13, FIG. 14, and FIG. 15 depict an exemplary interface 1100 in accordance with exemplary embodiments of the present invention. The interface 1100 in FIGS. 13-15 depicts a government profile in accordance with exemplary embodiments. A government profile may comprise a map interface 1360 for displaying a map of a municipality; a profile options interface 1364 for selecting the data to display in the profile; and a data display interface 1362 for displaying the data selected by the user with the profile options interface 1364. Some options that may be generally offered to a user in the profile options interface 1364 may comprise a tearsheet option for displaying selected data categories that provide a general overview of the entity; a municipal budget option for displaying a summary of a municipal budget compiled by the system of the present disclosure; a crime option for accessing and displaying crime data from public or private sources; an income option for indicating income data from public sources such as the U.S. Census or private sources; an unemployment option for displaying unemployment data from public sources such as the U.S. Bureau of Labor Statistics and/or private sources; a demographics option for displaying demographics and population data from public sources or private sources; and a property taxes option for displaying property tax data from public or private sources; and/or the like.

An exemplary display for the tearsheet option is depicted in FIG. 13; an exemplary display for the municipal budget is displayed in FIG. 14; and an exemplary display for the property taxes option is displayed in FIG. 15. In some embodiments of the present disclosure, the municipal budget option may display a budget that is selectable and filterable by the user. In some embodiments, the system may be adapted to analyze all data and calculate a forecasted figure for each piece of data. In addition the forecast, the system may be adapted to indicate if each piece of data meets a predetermined threshold and is therefore on the “right track” or the “wrong track”. The right track/wrong track determination may be made by the system based on the predetermined criteria, which may be configured by the administrator and/or another user, or the like.

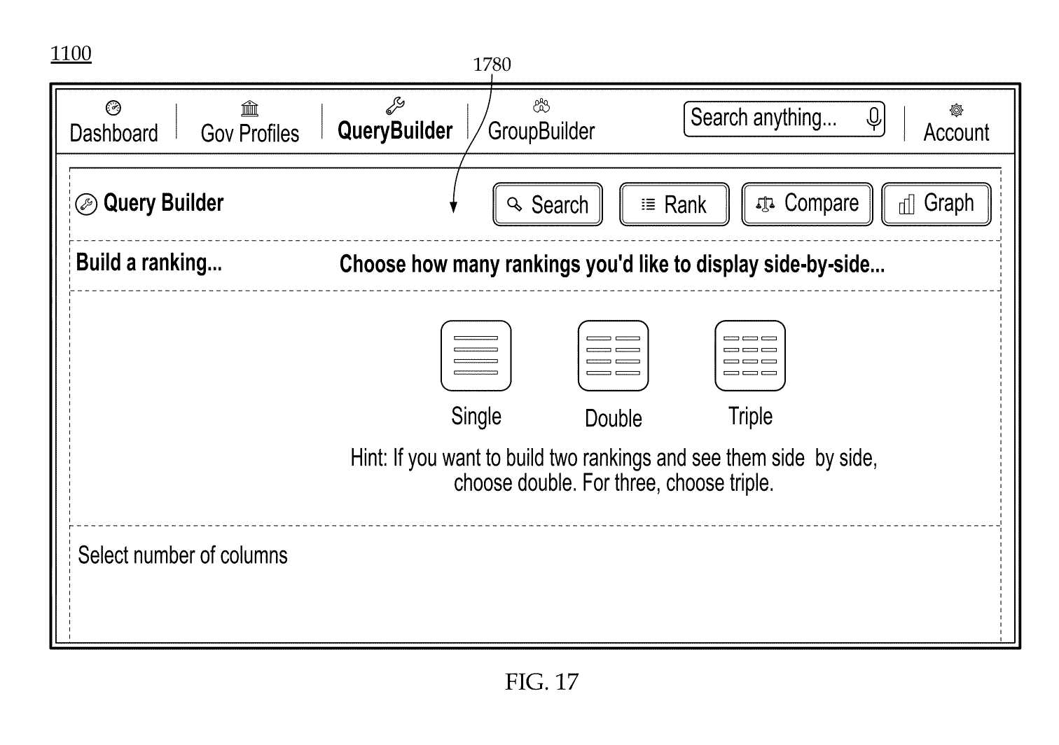

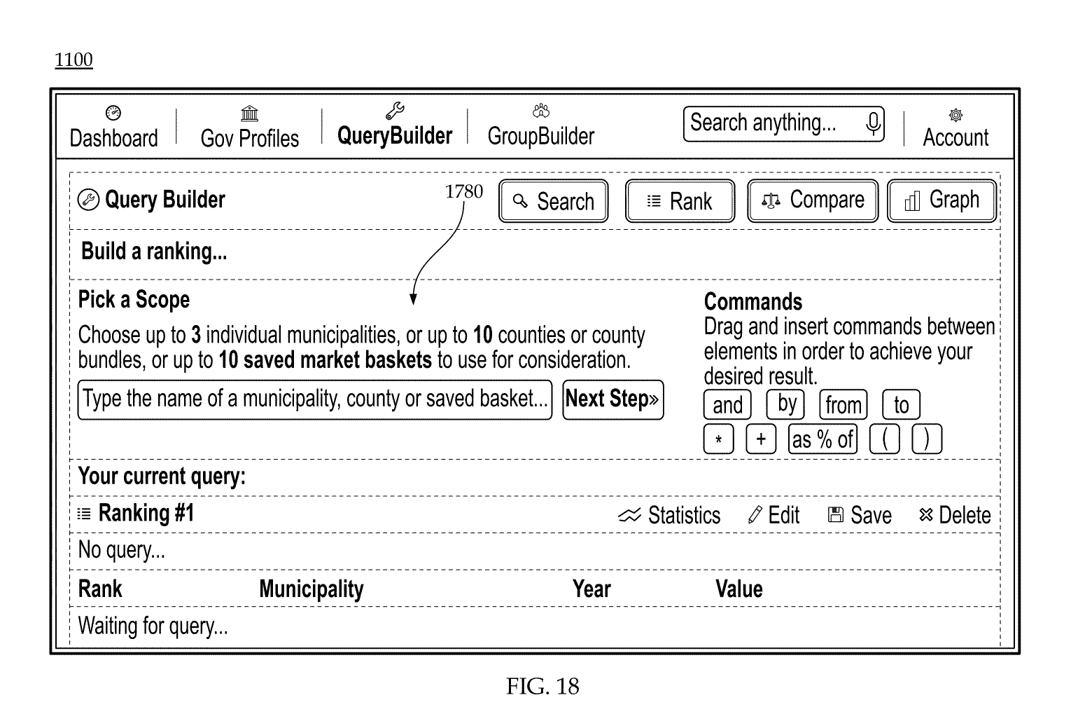

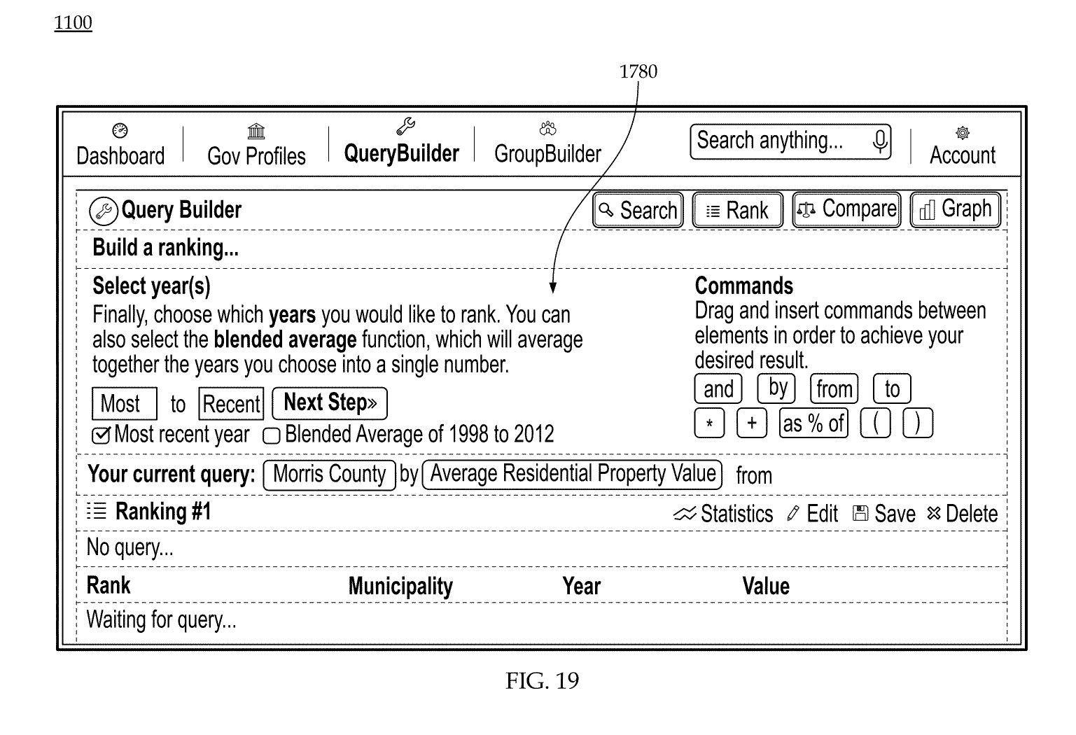

Referring back to FIG. 5, in exemplary embodiments, a system may comprise a Query Builder module 150, which may be adapted to allow users to parse, filter, and sort data, or the like. The Query Builder may present the user with a process: (1) scope selection (2) data selection (3) year selection. The scope selection step asks the user to specify which municipalities or governmental entities to consider in their query. FIG. 17, FIG. 18, and FIG. 19 depict these various steps in the process, respectively. As shown in FIGS. 17-19, the system may comprise a general interface 1100 that may provide the user with access to the Query Builder module interface 1780 for accessing the Query builder module 150. In some embodiments, the second step may present the user an option of identifying a dataset operator to consider, which the user may separate with specific mathematical commands (like +, −, *, or ÷), or the like. The third and generally final step may allow a user to specify which years of data to include in their results, or the like.

Referring back to FIG. 5, the system 140 may allow a user to manually enter data. In some embodiments, particular datasets required by the system may exist only on paper and therefore must be manually entered and scrubbed before they can be used. For example municipal budgets often are proprietary and exist only on paper. Once scanned or otherwise input into the system 140, the system 140 may be adapted to sort a municipal budget into a predetermined set of spending and revenue categories. For example, in New Jersey, a Municipal Data Sheet is required for submission annually by the state Department of Community Affairs and may be acquired for inputting into the system 140 either on paper from the State of New Jersey or via PDF from individual municipal websites. A budget analyst or an automated process within the system 140 may scan and review the budget and sort revenue and spending line items into standardized categories including revenue categories and expenditure categories. The system 140 may then subtotal individual budget line items together to get totals for each category. A budget analyst may manually enter resultant numbers or the system 140 may automatically store the resultant number and enter the data into a spreadsheet, or the like. The finalized numbers may then be reviewed with a policy director or a policy module of the system 140. During the review stage, a uniform methodology for making decisions on where specific line items logically apply may be utilized. For example, a policy director or policy module would move the salary line item for “Director of Public Works” into the “Public Works” category if the municipality had, for example, apportioned it to the “General Government” category, or the like. In some embodiments, the system 140 may finalize the spreadsheet. The finalized spreadsheet may be saved by the system or imported into the system. The system 140 may then recognize a custom data coding system, and automatically sort data into the relevant database cluster, or the like.

A system in accordance with exemplary embodiments may also perform trend forecasting and historical analysis. The system 140 may sit on top of a robust relational database 142 that contains both current year and historical data, thereby making advanced trend forecasting and regression analysis easy and straightforward. The system may generally be adapted to perform multi-year planning and cost forecasting for Governmental Accounting Standards Board (GASB) compliance. The extensive public data harvested by the system 140, and the ability for local government users to supplement and incorporate additional data into the system as needed, provides a platform for state and local governments to engage in multi-year planning and budgeting. The GASB requires multi-year budgeting of all state and local governments, including long-range pension and retiree health benefit liability analysis in future bond offerings. Few local governments possess the capability to perform this analysis and therefore bring them into compliance with this regulation. The system 140 may be adapted to utilize harvested individual pension data, including records for every individual in the pension system, coupled with actuarial liability formulas and investment risk modeling and Monte Carlo simulations to project future pension and retiree health benefit liabilities. The system 140 may comprise an easy to use software tool that enables this type of analysis to be done quickly, with the result being a PDF report that tabulates the necessary numbers for disclosure.

The system 140 may require certain data to make plan specific calculations. This data should be provided to the system 140 in aggregate for the entire plan, and also broken out by municipality in order to calculate the costs associated with each municipal government's level of participation in a Police and Firemen's Retirement System (PFRS) as determined by the number of employees participating and their demographic characteristics relevant to calculating pension payments. This data may comprise: salary, tenure and ages of active employees, or the age-service matrix; historical salary data is needed to calculate highest average salaries; benefit levels and ages of retirees; assumed mortality, separation and retirement rates; salary growth assumptions; and/or the like. To be useful for municipal governments, this data should be municipality specific as well as general for the entire plan. The system 140 may be constructed in a way that makes it easy to replicate with other plan data in other local governments and states. The system 140 output may contain the ability to interface with subsequent models.

In some embodiments, the system 140 may provide risk analysis for typical pension investments. The probability of default and the distribution of risk would provided by the system 140. This system 140 may also be adapted to provide a “what if” type model for various scenarios. The system 140 may estimate pension liabilities, run-out dates, and required contributions from both the state and local governments. The system 140 may provide the user with various graphs showing the length of time a pension plan can pay annuitants under various scenarios such as funding rate of interest and under different condition of financial risk, or the like.

In some embodiments of the present invention, a system 140 may calculate the normal cost and liability payment over a period of 30 years for a pension system, and break down theses costs by municipality to show how these costs are shared between the municipal and state levels. The system 140 may be adapted to calculate the total liability for a pension plan; the annual benefit payments; the normal costs annually for the state to fund the benefit; the normal costs; a likely run-out date given certain assumptions about asset performance; and/or the like.

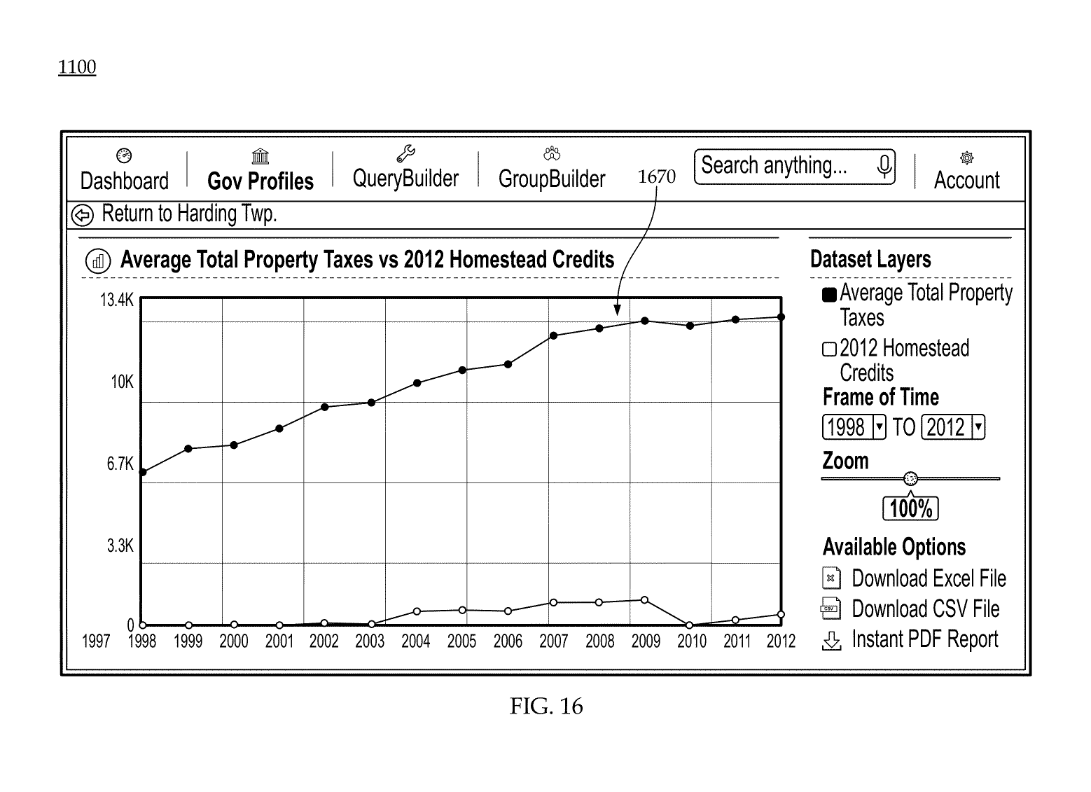

In exemplary embodiments, the analysis and reporting module 148 may be adapted to generate reports and graphs from the data stored in the database 142, or the like. FIG. 16 depicts an exemplary interface 1100 displaying a graph interface 1670 for graphically representing system data, or the like. In some embodiments, any type of graph may be used and the data to be included in the graph displayed by the graph interface 1670 may be configured by the user and/or an administrator. In some embodiments, the graph 1670 may comprise real time data and may dynamically update as the data stored by the database 142 changes, or the like. In some embodiments, the graph interface 1670 may enable a user to transmit, print, save, or the like, the graph generated by the graph interface 1670.

Referring back to FIG. 5, in accordance with exemplary embodiments of the present invention, the analysis and reporting module 148 may be adapted to analyze public or private data collected by the system 140. The analysis and reporting module 148 may be adapted to apply one or more algorithms or sets of rules against data collected by the system 140. The analysis and reporting module 148 may be adapted to find and/or identify data that a user searches for using a search interface, or the like. The analysis and reporting module 148 may compare the collected municipality, individual, or other entity data with data from other municipalities, individuals, or other entities, or the like. The analysis and reporting module 148 may also be adapted to generate reports comprising a summary of all users, entities administrators, and/or the like. The reports may be transmitted and/or displayed to the user and/or administrator via mobile communication device, email, postal mail, a report generated on the display of a computing device, and/or the like. In some embodiments, the reports may be generated by the reporting module 148 for custom entities selected by a user or by an administrator.

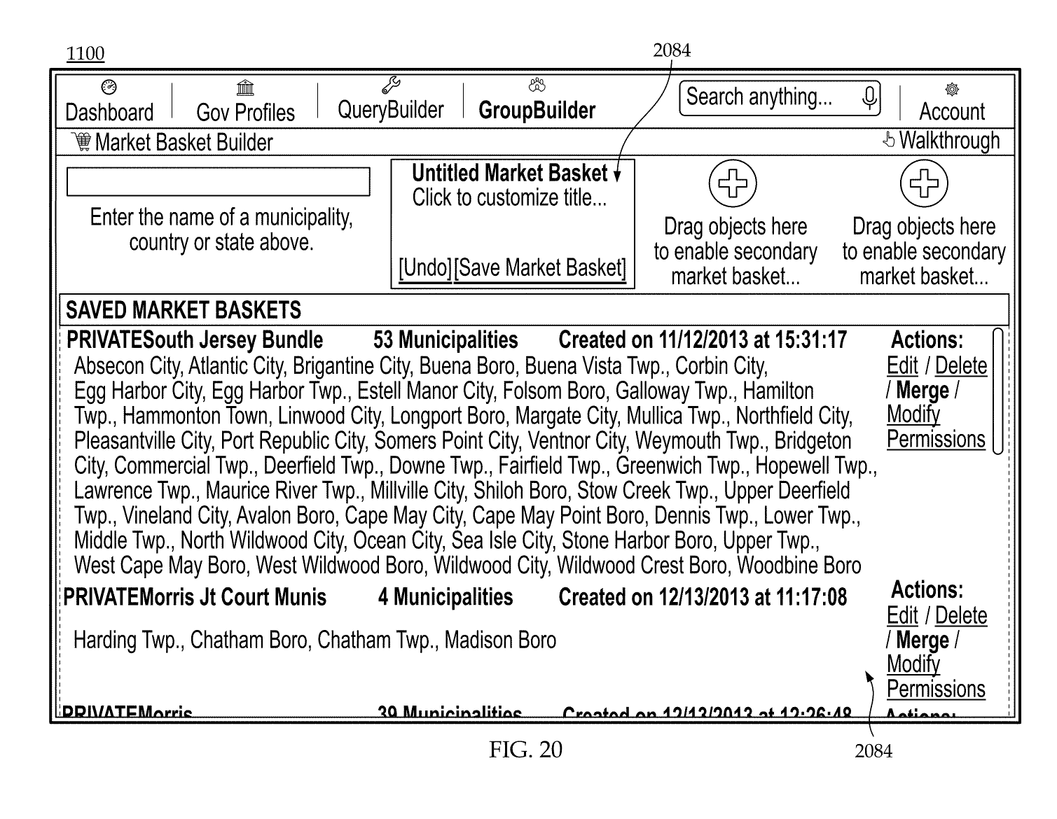

FIG. 20 depicts an exemplary interface 1100 in accordance with embodiments of the present invention. The interface 1100 depicted in FIG. 20 comprises a basket section interface 2084 and a listing of saved baskets 2084. The basket selection interface 2084 may enable a user to select a “market basket” comprising one or more individuals, municipalities, entities, congressional districts, school districts, and/or the like. For example, the user may wish to run a report on an area that is generally defined as a “northern” or “southern” part of a state, or the like. For example, a user may wish to run a report on all municipalities in “Southern New Jersey”; in a specific congressional or political district; in a school or educational district; and/or the like. In some embodiments, a map may be displayed to the user and the system may allow the user to select a geographic area for analysis. In this embodiment, the data saved in the system is associated with the displayed map, such that when a user selects a geographical area on a displayed map, data relevant to that area is displayed. In some embodiments, the user may choose to compare two or more market baskets, a market basket and a municipality, a market basket and an individual, any combination of entities, and/or the like. A system in accordance with exemplary embodiments may be adapted to calculate statistics and forecasting for the areas selected by the user in each market basket, geographic area, and/or the like.

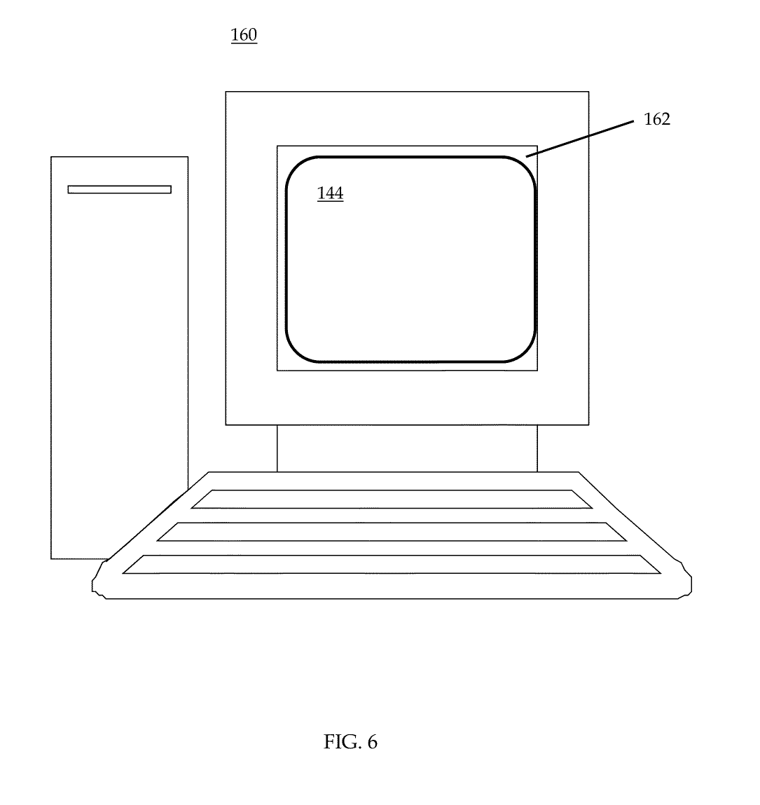

FIG. 6 depicts an exemplary client computer capable of being used with the system depicted in FIG. 1, in accordance with embodiments of the present invention. In exemplary embodiments, the client computer 160 may comprise a display 162. The display 162 may be adapted to display at least an interface 154. In exemplary embodiments, the functionality and appearance of the display may be determined by an interface module 144. The interface 154 may be adapted to display any data and analysis collected, stored, and/or analyzed by a system in accordance with embodiments of the present invention. Although a client computer 160 is depicted as a personal computer in FIG. 6, any computing device may be used. By way of example, a mobile phone, a tablet computer, a laptop computer, and/or the like may be used, to name a few.

While the foregoing is directed to exemplary embodiments of the present disclosure, other and further embodiments of the disclosure may be devised without departing from the basic scope thereof, and should be considered part of this disclosure, as if described fully herein. Specifically, whereas the worldwide web and mobile web are growing content and capabilities at ever-increasing rates, the ability to adapt the systems, methods, applications, and interfaces disclosed herein to existing or new mobile- or web-based technology is contemplated by embodiments of the present disclosure and does not depart the scope of the disclosure disclosed herein. In addition, embodiments of the present disclosure are further scalable to allow for additional users, clients, servers, and the like, as particular applications may require.

What is claimed is:

1. A computer-implemented method for benchmarking, accounting, analysis, and cost forecasting, the method comprising:
at a server having one or more processors and memory storing one or more programs for execution by the one or more processors:
harvesting raw data from a plurality of sources;
indexing the harvested data according to predetermined data categories relating to municipalities;
organizing the data based on the indexed data and the geographic location associated with the data;
storing the organized data in a database; and
generating and displaying a profile page for a selected region based on the organized data stored in the database.

2. The method of claim 1, wherein the raw data comprises a combination of public data and private data.

3. The method of claim 1, further comprising:
receiving a request to search the database for a municipality;
retrieving all data related to the municipality; and
generating and displaying a second profile page for the municipality comprising a selected group of data from the data related to the municipality.

4. The method of claim 3, wherein the selected group of data is configured by an administrator.

5. The method of claim 1, further comprising:
analyzing the organized data and indicating if the data meets a predetermined threshold.

6. The method of claim 5, wherein the predetermined threshold is configured by an administrator;

7. The method of claim 1, further comprising:
forecasting the expected future values of the organized data and displaying the forecasted data near real time data in a coherent display on the profile page.

8. The method of claim 1 wherein the selected region comprises at least one of a municipality, a county, a state, a voting district, an educational district, or a collection of entities.

9. The method of claim 1 wherein the selected region is selected by a user.

10. A computer-implemented method for benchmarking, accounting, analysis, and cost forecasting, the method comprising:
at a server having one or more processors and memory storing one or more programs for execution by the one or more processors:
harvesting raw data from a plurality of sources;
indexing the harvested data according to predetermined data categories relating to municipalities;
organizing the data based on the indexed data and the geographic location associated with the data;
storing the organized data in a database;
generating and displaying a profile page for a selected region based on the organized data stored in the database;
analyzing the organized data and indicating if the data meets a predetermined threshold; and
forecasting the expected future values of the organized data and displaying the forecasted data near real time data in a coherent display on the profile page.

11. The method of claim 11, wherein the raw data comprises a combination of public data and private data.

12. The method of claim 10, further comprising:
receiving a request to search the database for a municipality;
retrieving all data related to the municipality; and
generating and displaying a second profile page for the municipality comprising a selected group of data from the data related to the municipality.

13. The method of claim 10, wherein the selected group of data is configured by an administrator.

14. The method of claim 10, wherein the predetermined threshold is configured by an administrator;

15. The method of claim 10 wherein the selected region comprises at least one of a municipality, a county, a state, a voting district, an educational district, or a collection of entities.

16. The method of claim 1 wherein the selected region is selected by a user.

17. A system comprising at least one server, the server comprising:
one or more processors; and
memory;
wherein the at least one server is adapted to:
harvest raw data from a plurality of sources;
index the harvested data according to predetermined data categories relating to municipalities;
organize the data based on the indexed data and the geographic location associated with the data;
store the organized data in a database; and
generate and display a profile page for a selected region based on the organized data stored in the database.

18. The system of claim 17, wherein the at least one server is further adapted to:
receive a request to search the database for a municipality;
retrieve all data related to the municipality; and
generate and displaying a second profile page for the municipality comprising a selected group of data from the data related to the municipality.

19. The system of claim 17, wherein the at least one server is further adapted to analyze the organized data and indicating if the data meets a predetermined threshold.

20. The system of claim 17, wherein the at least one server is further adapted to forecast the expected future values of the organized data and display the forecasted data near real time data in a coherent display on the profile page.
